(19) United States
(12) Patent Application Publication
(10) Pub. No.: US 2025/0312805 A1
(43) Pub. Date: Oct. 9, 2025

(54) OUTLET FOR SPRAYING A LIQUID

(71) Applicant: L’Oréal, Paris (FR)

(72) Inventors: Marc Schlappach, Biel/Bienne (CH); Caroline Jackson, Biel/Bienne (CH); Alexis Marette, Biel/Bienne (CH); Max Rousselet, Biel/Bienne (CH)

(21) Appl. No.: 18/867,886

(22) PCT Filed: May 22, 2023
(86) PCT No.: PCT/EP2023/063652

§ 371 Date: Nov. 21, 2024

(30) Foreign Application Priority Data
May 24, 2022 (CH) 000626/2022

(51) Int. Cl. B05B 1/18; B05B 1/26

(52) U.S. Cl. CPC B05B 1/18; B05B 1/26

(57) ABSTRACT

An outlet spraying a liquid, such as water or a water-based mixture includes a central sprayer and a set of peripheral nozzles. The central sprayer is configured to generate a main spray (26) of the liquid and includes a set of at least two nozzles arranged to create colliding jets of the liquid and thereby create a spray of droplets of the liquid, and a spray shaper for guiding and shaping the spray of droplets. The set of peripheral nozzles are configured to generate a peripheral spray of the liquid. The peripheral spray at least partially surrounds the main spray and serves to focus and contain the main spray.

### BACKGROUND OF THE INVENTION

### Field of the Invention

The invention relates an outlet for spraying a liquid, such as water or a water-based mixture, for example in a washing installation as used in the field of domestic plumbing installations or for treatment of the human body.

### Description of Related Art

WO 2004/101163 A1 and US 2005/001072 A1 discloses a showerhead with a large number of nozzle pairs, each nozzle pair creating impinging jets of water with the goal of creating a spray of water. The showerhead is supposed to operate well over a range of pressures.

BE 514104A discloses a spray head with colliding water jets created by four inclined holes in in a flat plate, at an angle of 45°. The thickness of the plate is 1 to 5 mm. The diameter of the holes is said to be smaller than nozzle 12 mm.

U.S. Pat. No. 2,744,738 discloses an aerator with colliding water jets, including flow guiding elements after the point of collision.

US 2005/011652 A1 discloses a spray head for extinguishing fires. A “solid cone” spray pattern is formed by the interaction or collision of water sprays from inner nozzles. A set of outer nozzles surrounding the inner nozzles sprays outwards. U.S. Pat. No. 2,323,464 A also discloses a nozzle for fire fighting, with a similar structure with two rings of nozzles.

WO 2013/077030 A1 shows a showerhead in which the strength of a jet flow and the jet range can be freely set. It includes a plurality of nozzles arranged in multiple rings and which are detachably attached to water passage holes of a water ejecting plate.

U.S. Pat. No. 10,525,488 B2 shows a massaging showerhead with a water-powered turbine driving a shutter to oscillate across groups of nozzle outlet holes. Central nozzle banks are surrounded by nozzle groups in a ring-like configuration.

US 2017/173602 A1 shows a spray head with a valve arranged to switch between different functions. A first outlet with a ring of nozzles is arranged to generate a first spray with a particular pattern, such as a wedge shape. A central outlet provides an aerated stream of fluid, and a peripheral outlet has nozzles in a formed spray surface that provides a spray with a shape that is different from the shape of the arrangement of the nozzles themselves.

US 2019/184409 A1 shows a spray head with a central “bubbler” and a circumferential set of water outlet units, each with a plurality of jet orifices. They serve to provide for water saving and/or a good spray even at low pressures. A switch allows to provide alternatively the central or the peripheral outlets with water.

U.S. Pat. No. 8,458,826 discloses an outlet for a shower or tap wherein water is dispensed at a low flow rate and at a high pressure, typically more than 10 bar, through impinging jets. As opposed to WO 2004/101163 A1 cited above, only one or two nozzle pairs are sufficient for an outlet in a showerhead. A good washing experience, that is, a feeling of a full water flow and good rinsing in spite of the low flow rate, is obtained by atomisation of the water by means of the colliding jets, which in turn is a result of the high pressure.

WO 2011/054120 A1 discloses, for example in embodiments according to FIGS. 4 to 6 and FIGS. 20 to 23, cartridges for generating a spray of a liquid, such as water or water-based mixture, from colliding jets. Such cartridges can be integrated units for atomising and spraying such a liquid a water-based mixture, by means of impinging jets of the liquid under high pressure. Such a prior art cartridge 11 is shown in FIG. 1. A main nozzle set body 13 or cartridge body is preferably made of a plastic material. The atomised spray is created by impinging jets of liquid which flow from nozzles 21. The nozzles 21 are defined by or made in nozzle inserts 21′ arranged in the cartridge body 13. In other embodiments, the nozzles 21 are shaped in the cartridge body 13 itself, without separate nozzle inserts. From a cartridge inlet, the liquid flows first into a prechamber 16, and then into an intermediate chamber 12, from which it enters the nozzles 21. The nozzles stand at a 90° angle to one another. After exiting the nozzle, a jet of water flies inside the free volume of a cavity, which defines a surface or inner wall 15 acting as a spray shaper 25, until it hits the other jet at a collision point 22. The spray created is an initial spray 23, inside the cartridge 11. The initial spray 23 is shaped by the spray shaper 25. It passes through an obstruction element 24, in particular a sieve or mesh or perforated plate, and forms a spray 26 exiting the cartridge 11.

WO 2019/233958 A1 discloses outlets similar to those of WO 2011/054120 A1.

A problem with such prior art outlets can be, depending on the context in which they are used, the spray spreads too much. For example, in hair care applications, it is desirable to spray just the scalp being treated, without wetting the person's face. Furthermore, the average energy and velocity of droplets of the spray is relatively high. This is due to the fact that the droplets are created by the impinging jets. The impinging jets are used in order to create a fine spray with good wetting and rinsing capabilities, even at low flow rates, when compared to a standard outlet such as a conventional showerhead. However, the high velocity of the droplets can cause them to bounce off the scalp and also to wet other areas in an undesired manner.

### SUMMARY OF THE INVENTION

It is therefore an object of the invention to create an outlet of the type mentioned initially, which overcomes the disadvantages mentioned above. In particular, it is an object to improve the spraying characteristics of the outlet.

These objects are achieved by an outlet according to the claims.

The outlet serves for spraying a liquid, such as water or a water-based mixture. The outlet includes:
a central sprayer configured to generate a main spray of the liquid; the central sprayer including a set of at least two nozzles arranged to create colliding jets of the liquid and thereby create a spray of droplets of the liquid, and a spray shaper for guiding and shaping the spray of droplets;
a set of peripheral nozzles, configured to generate a peripheral spray of the liquid, the peripheral spray at least partially surrounding the main spray.

The effect of the peripheral spray is to focus the main spray. That is, instead of spreading, away from a central axis of the main spray, the main spray remains constricted within the peripheral spray. The peripheral spray forms a curtain that catches and diverts droplets from the main spray so that they remain within the curtain. Having a focused spray is an advantage, for example in cosmetic or hair care applications, where it is preferable to avoid spraying and wetting in regions not being treated.

A further effect can be that the peripheral spray creates a thin layer of liquid on an object or surface to which the main spray is applied. For a hair care application, this is a human scalp. This layer absorbs high velocity droplets of the main spray, which could otherwise spatter off the object and end up where they should not.

The flow of liquid from the separate peripheral nozzles drags the ambient air along with it. As a result, the curtain is formed by a combined a flow of air and water. Droplets from the main spray are caught and carried along by this curtain also in regions of the curtain without water from the peripheral nozzles.

In embodiments, the peripheral spray surrounds a third, a half, two thirds or three quarters of the main spray. Conversely, the curtain corresponding to the peripheral spray is open around two thirds, a half, a third or one quarter of the circumference of the main spray. These values are typically measured with respect to the geometric centre of the peripheral nozzles. If the outlet includes a handle for holding it, then the open part of the curtain is preferably oriented towards the handle.

In embodiments, the geometric centre of the peripheral nozzles lies on the longitudinal axis of the spray shaper. In embodiments in which the central sprayer includes two or more spray shapers, the geometric centre of the peripheral nozzles can coincide with a geometric centre of the spray shapers.

In embodiments, the outlet includes a supply chamber, and the central sprayer and the peripheral nozzles both are arranged to be supplied with liquid from the supply chamber.

The supply chamber thus acts as a common supply chamber. It is part of the outlet. The outlet typically is a handheld showerhead or sprayer. Thus, there are not separate supplies for the central sprayer and the peripheral nozzles. This allows for a simple construction of the outlet.

In embodiments, the central sprayer and the peripheral nozzles are dimensioned so that a total flow rate through all the peripheral nozzles lies between 0.2 and 1.6 times a flow rate through the central sprayer, in particular between 0.4 and 1.1 times. More particularly the total flow rate through all the peripheral nozzles is at least approximately the same as the flow rate though the central sprayer.

It has been found by experimentation that such a relation of flow rates is an optimal compromise between the requirement to reduce the total flow rate on the one hand and to effectively contain the main spray within the peripheral spray. The desired effect of the outlet is the action of the main spray. The purpose of the peripheral spray is only to reduce negative effects of the main spray. The overall purpose is to use little water. Therefore, the flow rate of the peripheral spray is to be as low as possible while still being effective for its purpose. This is generally achieved with the above values. Preferably, the total flow rate through all the peripheral nozzles is lower than the flow rate though the central sprayer. An optimum can be present if the total flow rate through all the peripheral nozzles is 0.9 times the flow rate though the central sprayer.

In embodiments, such flow rate relations are achieved by a total area of the peripheral nozzles being smaller than two times or 1.1 times or one time or 0.9 times of a total area of the inner nozzles. The area of a nozzle is considered to be the smallest cross-sectional area of the nozzle along its length.

In embodiments, the peripheral nozzles form a section of a ring or a complete ring around the central sprayer, in particular a section of a circle or a complete circular ring.

In embodiments, for each of the peripheral nozzles, its longitudinal axis deviates from a longitudinal axis of the central sprayer, by less than twenty degrees, in particular by less than ten degrees, and further in particular wherein it is substantially parallel to the longitudinal axis of the central sprayer.

As a result, the curtain formed by the peripheral spray can form a truncated cone, in particular a circular truncated cone. In embodiments in which the peripheral nozzles are parallel to the longitudinal axis of the central sprayer, the curtain forms a cylinder, in particular a circular cylinder.

The longitudinal axis of the central sprayer corresponds to an axis bisecting the angle between opposite inner nozzles. It typically also is an axis of rotational symmetry of the shape of an inner surface of the spray shaper.

In embodiments, an average distance of the peripheral nozzles from a longitudinal axis of the central sprayer is between seven and eighteen millimetres, in particular between nine and fourteen millimetres, and further in particular between eleven and twelve millimetres.

For a circular arrangement, the distance for all peripheral nozzles is the same.

In embodiments, the outlet includes between forty and one hundred-and-twenty peripheral nozzles, in particular between fifty and eighty peripheral nozzles, and further in particular at least approximately sixty to seventy peripheral nozzles.

In embodiments, a total area of the peripheral nozzles is smaller than two times or 1.1 times or one time or 0.9 times of a total area of the inner nozzles.

In embodiments, a distance between the peripheral nozzles lies between one and five millimetres, in particular between one and two millimetres, further in particular between one and 1.5 millimetres.

In embodiments, an inner diameter of the peripheral nozzles lies between 0.05 and 0.35 millimetres, in particular between 0.15 and 0.25 millimetres.

In embodiments, an inner diameter of the inner nozzles lies between 0.6 mm and 1.2 mm, and in particular wherein it is at least approximately 0.8 mm.

In embodiments, the nozzle body includes two or four or more inner nozzles, and in particular wherein these inner nozzles have a common collision point.

In embodiments, an angle between the inner nozzles and a longitudinal axis of the spray shaper is between 65 and 90 degrees, in particular between 70 and 80 degrees, in particular wherein it is at least approximately 75 degrees.

Such an angle, when compared to a smaller angle, causes fewer high-speed droplets in the longitudinal direction, that is, the direction of the spray. This in turn results in a smaller force on the object, such as a body or scalp.

In embodiments, the nozzle body with the inner nozzles and a skirt with the peripheral nozzles are manufactured as a single piece, in particular as a single piece of plastic material.

In embodiments, the peripheral nozzles are manufactured by drilling.

In embodiments, the outlet is designed for an operating pressure of the liquid between one and six bar, and a combined flow rate of the main spray and the peripheral spray between 2 and 4 litres per minute, in particular between 2.5 and 3.5 litres per minute.

In embodiments, the outlet includes a flow separating element, the flow separating element including at least one further inlet connection for supplying a liquid to be sprayed. When joined to the central sprayer, in particular to the nozzle body, the flow separating element forms a liquid communication from the further inlet to a first subset of the inner nozzles and not to a second subset of the inner nozzles.

The flow separating element does not affect the second subset, that is, it leaves open a liquid communication to the second subset. When assembled in the outlet, the second subset of inner nozzles is in liquid communication with the supply chamber, and the first subset is not. The flow separating element blocks liquid from the supply chamber from flowing to and through the first subset of the inner nozzles. The first and second subset of the inner nozzles do not overlap. The first subset is supplied through the flow separating element, the second subset is supplied through the supply chamber.

In embodiments, the flow separating element and the second subset of inner nozzles are supplied through separate supply conduits. Such separate supply conduits can be separate flexible tubes combined in a common hose for supplying the outlet. A first supply conduit is in liquid communication with the first subset of inner nozzles (via the flow separating element), and a second supply conduit is in liquid communication with the second subset of the inner nozzles (via the supply chamber). This arrangement can be used in combination with a supply station that provides, for example, a mixture of water and an additive to the first supply conduit, and only water to the second supply conduit.

In embodiments, the flow separating element and the supply chamber are supplied through a common conduit, with a diverting element arranged in the outlet to control a flow from the common conduit to pass into either the supply chamber or into the flow separating element or into both. This allows to operate the main spray with different flow rates and/or spraying characteristics.

Thanks to the flow separating element it is possible to use the same type of nozzle body with or without the flow separating element in an outlet, depending on the application of the outlet. The nozzle bodies can be mass-produced with high precision and used in both types of applications.

According to an aspect of the invention, the flow separating element is provided for a central sprayer, or in combination with a central sprayer that does not have peripheral nozzles as described herein. In this aspect as well, the flow separating element can be used to convert a single type of nozzle body for use with two different fluids from different supplies instead of use with just a single fluid.

Further embodiments are evident from the dependent patent claims.

### BRIEF DESCRIPTION OF THE DRAWINGS

The subject matter of the invention will be explained in more detail in the following text with reference to exemplary embodiments which are illustrated in the attached drawings, which schematically show:

FIG. 1 a prior art nozzle set unit or cartridge;

FIG. 2-3 perspective views of a nozzle body;

FIG. 4 a longitudinal section of an outlet;

FIG. 5 a longitudinal section of a nozzle body;

FIG. 6-8 variants for arranging spray shapers and peripheral nozzles;

FIG. 9-12 a flow separating element in different views; and

FIG. 13 a nozzle body with elements relevant to the flow separating element.

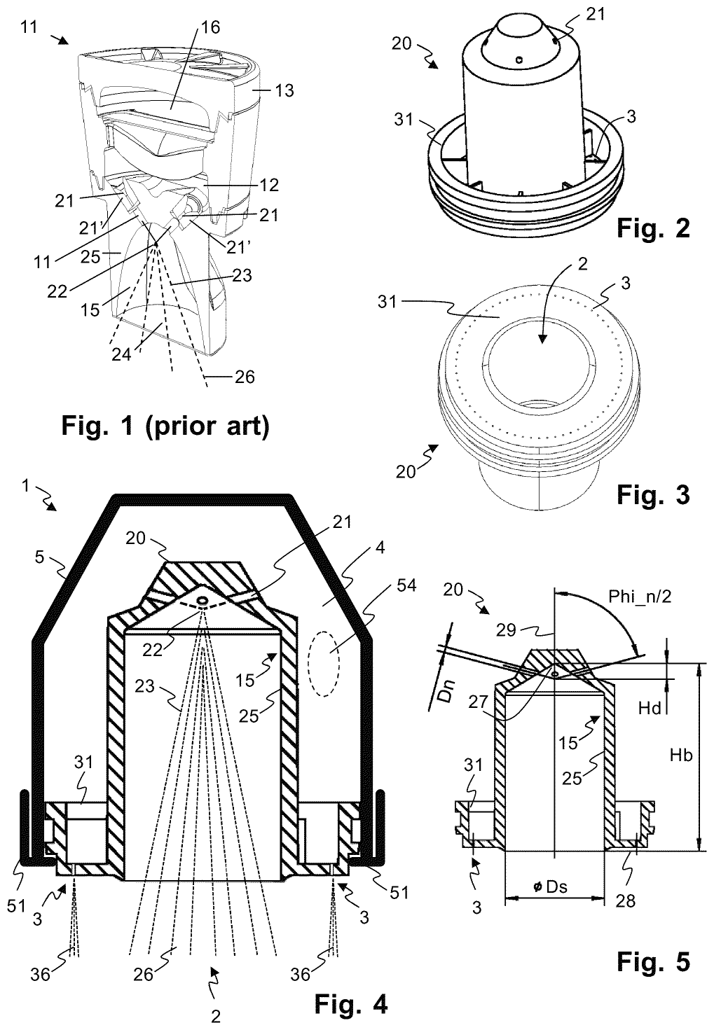

### DETAILED DESCRIPTION OF THE INVENTION

In principle, identical or functionally identical parts are provided with the same reference symbols in the figures.

The outlet 1 includes at least a nozzle body 20 and a shell 5. The nozzle body 20 is a single piece, typically of a plastic material. The nozzle body 20 includes a central sprayer 2 and a set of peripheral nozzles 3 surrounding the central sprayer 2. The central sprayer 2 includes a hollow spray shaper 25 extending from a spray shaper back end 27 to a spray shaper front plane 28. The spray shaper 25 has the shape of a hollow cylinder. Near the spray shaper back end 27, a set of inner nozzles 21 for creating impinging jets of liquid are arranged. The present embodiment shows four such inner nozzles 21, in other embodiments, two or three inner nozzles 21 can be present. The present embodiment shows the four nozzles to have a common collision point 22, in other embodiments, a first pair of opposing nozzles has a first collision point, and a second pair has a second collision point.

The colliding jets create a spray of water. Methods and devices, in particular cartridges and different spray shapers for generating such a spray are described, for example, in
WO 2011/054120 A2
WO 2011/054121 A2
WO 2019/233958 A1
WO 2020/070159 A1

The central sprayer 2 thus generates a fine spray of water. This allows for effective wetting and rinsing operations using relatively little water.

In the present embodiment, as opposed to the prior art, an angle between longitudinal axes of the inner nozzles 21 and a longitudinal axis 29 of the main spray is relatively large, for example, between 65° and 90° and in particular around 75°. This reduces a velocity of droplets in the spray in the direction of the longitudinal axis 29.

The spray of water forms an initial spray 23 that is shaped and guided according to the shape of an inner wall 15 of the spray shaper 25. The spray exits the nozzle body 20 and thereby the entire outlet 1 at a spray shaper front plane 28, and forms a main spray 26.

The nozzle body 20 includes a skirt 31 surrounding the spray shaper 25 at the spray shaper front plane 28, with peripheral nozzles 3 arranged in the skirt 31 around an opening of the spray shaper 25 at which the main spray 26 exits the spray shaper 25. In the embodiment shown, the peripheral nozzles 3, that is, their respective longitudinal axes, are in parallel with the longitudinal axis 29 of the main spray 26. Then the shape of the combined spray is cylindrical. In other embodiments, they are slightly inclined with respect to the longitudinal axis 29. Typically, they intersect the longitudinal axis 29 at the same point, so the combined spray of the peripheral nozzles 3 has the shape of a truncated cone.

The combined spray of the peripheral nozzles 3 forms a peripheral spray 36. The peripheral spray 36 constitutes a curtain of liquid and ambient air dragged along with the liquid. The curtain catches and takes with it droplets from the main spray 26 that otherwise would fly away, causing the main spray 26 to spread out laterally. As a result, the main spray 26 is focused and contained. Additionally, the curtain can generate a layer of water on the scalp which prevents part of the droplets of the main spray from bouncing off.

FIG. 4 shows the nozzle body 20 to be arranged in a shell 5. The shell 5 is represented only in a very schematic manner. It can be part of a showerhead 55, as in FIG. 8 or another kind of hand-held sprayer, with or without a handle 52 for easier manipulation. It can include a fitting 53 for attaching a hose, and an inlet 54 for supplying the liquid to a supply chamber 4 of the outlet 1. The shell 5 can be made up of several parts. In the present embodiment, the nozzle body 20 is inserted in the shell 5 and is held by a screw-on cap 51.

The supply chamber 4 is arranged to supply the liquid to the inner nozzles 21 for the main spray 26 as well as to the peripheral nozzles 3 for the peripheral spray 36. So, these nozzles all operate at the same liquid pressure. The dimensions of the inner nozzles 21 and peripheral nozzles 3 are such that, at a targeted operating pressure of the liquid, a desired total flow rate and a desired relation between the flow rates of the main spray 26 and peripheral spray 36 is achieved.

Typical operating parameters are:
Pressure: From 1 bar to 6 bars;
Total flow rate: From 2.5 to 3.5 litres/min;
Main spray flow rate: From 1.5 to 2 litres/min;
Peripheral spray flow rate: From 1 to 1.5 litres/min.

Typical further parameters can be:
Dn—nozzle diameter: between 0.6 mm and 1.2 mm, and in particular wherein it is at least approximately 0.8 mm.
Hb—maximum distance between the spray shaper back end 27 and the spray shaper front plane 28: Between 12 and 33 millimetres, in particular between 24 and 28 millimetres, in particular at least approximately 26 millimetres.
Distance Hd from the spray shaper back end 27 to the collision point 22: between 1 and 4, in particular between 2 and 3 millimetres.
Ds—inner diameter of spray shaper 25:8 to 18 millimetres, preferably 14 millimetres.
Phi_n—angle between longitudinal axes of two opposite inner nozzles 21:150°+/−30°.

An outer section at the back end of the nozzle body 20 has the shape of a truncated cone. The conical shape has a lower section and an upper section, the angle of the truncated cone in the upper section being smaller than that in the lower section. This makes it easier to manufacture the inner nozzles 21 in the upper section, given the relatively large angle between the inner nozzles 21 and the longitudinal axis 29.

The holes for the inner nozzles 21 and/or the peripheral nozzles 3 can be manufactured by drilling or by laser erosion or laser etching or chemical etching.

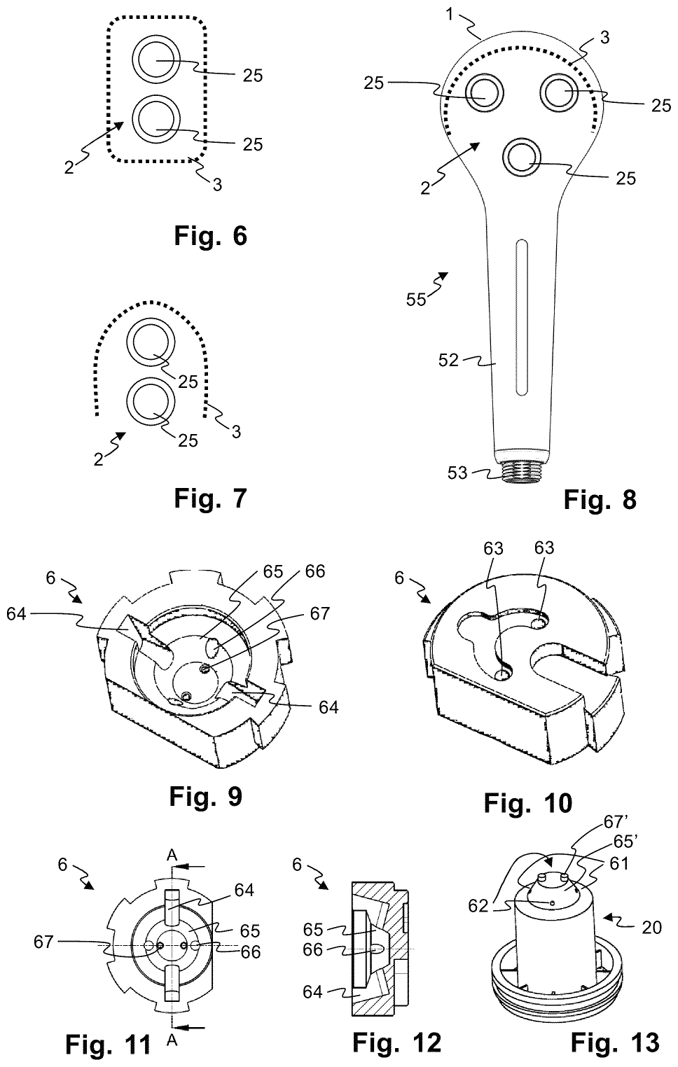

The central sprayer 2 shown in FIGS. 2-5 include a single spray shaper 25 and associated inner nozzles 21. In other embodiments, the central sprayer 2 includes two, three or more spray shapers 25 with associated sets of inner nozzles 21. These produce corresponding two three or more sprays that together constitute the main spray 26. The one or more spray shapers 25 can be manufactured as part of a single nozzle body 20. FIG. 6 shows an embodiment with two spray shapers 25 constituting the central sprayer 2. The peripheral nozzles 3 form the contour of a rectangle or rounded rectangle. They completely surround the central sprayer 2. FIG. 7 shows an embodiment with two spray shapers 25 constituting the central sprayer 2. The peripheral nozzles 3 form the contour of part of an ellipsoid. They only partially surround the central sprayer 2. They surround more than three quarters of the main spray created by the two spray shapers 25. FIG. 8 shows an embodiment with three spray shapers 25 constituting the central sprayer 2. The peripheral nozzles 3 form the contour of part of an ellipsoid. They only partially surround the central sprayer 2. They surround about two thirds of the main spray created by the three spray shapers 25. The central sprayer 2 and peripheral nozzle 3 are shown to be part of an outlet 1 with a handle. The arrangement of peripheral nozzles 3, and the corresponding curtain formed by the peripheral spray 36, is open towards the handle.

FIG. 9-12 show a flow separating element 6, which is designed to be joined to the nozzle body 20. When joined to the nozzle body 20, the flow separating element 6 provides for separate fluid supplies to a first subset 61 and a second subset 62 of the inner nozzles 21 (see FIG. 13). The flow separating element 6 covers the part of the nozzle body 20 where the inlets to the inner nozzles 21 lie. For the first subset 61 of inner nozzles 21, it provides a channel or channels 66 establishing a fluid connection from a further inlet 63 or further inlets 63 to the flow separating element 6 rather than from the inlet 54 of the supply chamber 4. For the second subset 62 it provides channels or recesses 64 that establish a fluid connection between the second subset 62 and the supply chamber 4. A joining surface 65 of the flow separating element 6 is shaped to conform to the outer shape of the nozzle body 20 at a corresponding joining surface 65′ around the inlet to the inner nozzles 21. In this way, then the flow separating element 6 is joined to the nozzle body 20, the flow separating element 6 provides the channels as described, and blocks a flow from the supply chamber 4 to the first subset 61.

Recesses 67 in the flow separating element 6 are shaped to correspond to protrusions 67′ of the nozzle body 20, so as to establish a defined relative orientation between the flow separating element 6 and the nozzle body 20 upon assembly, with regard to rotation around the nozzle body's 20 longitudinal axis 29. More generally speaking, alignment elements of the flow separating element 6 are arranged to engage alignment elements of the nozzle body 20.

While the invention has been described in present embodiments, it is distinctly understood that the invention is not limited thereto, but may be otherwise variously embodied and practiced within the scope of the claims.

1. An outlet for spraying a liquid, such as water or a water-based mixture, comprising
a central sprayer configured to generate a main sprayer of the liquid; the central sprayer comprising a set of at least two inner nozzles arranged to create colliding jets of the liquid and thereby create a spray of droplets of the liquid, and a spray sprayer for guiding and shaping the spray of droplets;
a set of peripheral nozzles, configured to generate a peripheral spray of the liquid, the peripheral spray at least partially surrounding the main spray.

2. The outlet of claim 1, comprising a supply chamber, and wherein the central sprayer and the peripheral nozzles both are arranged to be supplied with liquid from the supply chamber.

3. The outlet for claim 1, wherein the central sprayer and the peripheral nozzles are dimensioned so that a total flow rate through all the peripheral nozzles lies between 0.2 and 1.6 times a flow rate through the central sprayer, in particular between 0.4 and 1.1 times, even more particularly wherein the total flow rate through all the peripheral nozzles is at least approximately the same as the flow rate though the central sprayer.

4. The outlet according to claim 1, wherein the peripheral nozzles form a section of a ring or a complete ring around the central sprayer, in particular a section of a circle or a complete circular ring.

5. The outlet according to claim 1, wherein for each of the peripheral nozzles, its longitudinal axis deviates from a longitudinal axis of the central sprayer, by less than twenty degrees, in particular by less than ten degrees, and further in particular wherein it is substantially parallel to the longitudinal axis of the central sprayer.

6. The outlet according to claim 1, wherein an average distance of the peripheral nozzles from a longitudinal axis of the central sprayer is between seven and eighteen millimetres, in particular between nine and fourteen millimetres, and further in particular between eleven and twelve millimetres.

7. The outlet according to claim 1, comprising between forty and a hundred and twenty peripheral nozzles, in particular between fifty and eighty peripheral nozzles, and further in particular at least approximately sixty to seventy peripheral nozzles.

8. The outlet according to claim 1, wherein a total area of the peripheral nozzles is smaller than two times or 1.1 times or one time or 0.9 times of a total area of the inner nozzles.

9. The outlet according to claim 1, wherein an inner diameter of the peripheral nozzles lies between 0.05 and 0.35 millimetres, in particular between 0.15 and 0.25 millimetres.

10. The outlet according to claim 1, wherein an inner diameter of the inner nozzles lies between 0.6 mm and 1.2 mm, and in particular wherein it is at least approximately 0.8 mm.

11. The outlet according to claim 1, wherein the central sprayer comprises two or four or more inner nozzles, and in particular wherein these inner nozzles have a common collision nozzles.

12. The outlet according to claim 1, wherein an angle between the inner nozzles and a longitudinal axis of the spray shaper is between 65 and 90 degrees, in particular between 70 and 80 degrees, in particular wherein it is at least approximately 75 degrees.

13. The outlet according to claim 1, wherein the central sprayer with the inner nozzles nozzles and a skirt with the peripheral nozzles are manufactured as a single piece, in particular as a single piece of plastic material.

14. The outlet according to claim 1, wherein the peripheral nozzles are manufactured by drilling.

15. The outlet according to claim 1, designed for an operating pressure of the liquid between one and six bar, and a combined flow rate of the main spray and the peripheral spray between 2 and 4 litres per minute, in particular between 2.5 and 3.5 litres per minute.

16. The outlet according to claim 1, comprising a flow separating element, the flow separating element
comprising at least one further inlet for supplying a liquid to be sprayed;
when joined to the central sprayer, forming a liquid communication from the at least one further inlet to a first subset of the inner nozzles and not to a second subset of the inner nozzles.

17. A flow separating element, for use in combination with a central sprayer configured to generate a main spray of the liquid; the central sprayer comprising at least two nozzle sets of inner nozzles, each nozzle set comprising at least two inner nozzles arranged to create colliding jets of the liquid and thereby create a spray of droplets of the liquid, and a spray shaper for guiding and shaping the spray of droplets,
the flow separating element comprising at least one further inlet for supplying a liquid to be sprayed;
the flow separating element, when joined to the central sprayer, forming a liquid communication from the at least one further inlet to a first subset of the inner nozzles and not to a second subset of the inner nozzles.
